(19) United States
(12) Patent Application Publication
(10) Pub. No.: US 2005/0047504 A1
(43) Pub. Date: Mar. 3, 2005

(54) Data stream encoding method and apparatus for digital video compression

(76) Inventors: Chih-Ta Star Sung, Glonn (DE); Yen-Chieh Ouyang, Taichung (TW)

Correspondence Address: Chih-Ta Star SUNG;RM. 105, BULD. 53, NO. 195, SEC. 4, CHUNG HSING RD., CHUTUNG TOWN, HSINCHU HSIEN, 310, TW

(21) Appl. No.: 10/653,585

(22) Filed: Sep. 3, 2003

(51) Int. Cl. H04N 7/12

(52) U.S. Cl. 375/240.2; 375/240.16; 375/240.24; 375/240.12

(57) ABSTRACT

The invention provides method and apparatus of video bit stream encoding. In non-intra type encoding, block pixel differences between a target block and the corresponding best match block is compared to other blocks' to determine whether a bit stream of a previously compressed block can be used to represent a target block. In Intra-coding, a target block is compared to other blocks to determine whether a bit stream of a previously compressed block can represent the target block. Should variance range of a block pixel of an intra-coded frame or block pixel differences of a non-intra coding frame is less than predetermined thresholds, the DC coefficient is represented by a predetermined value, or a certain amount of AC coefficients are calculated.

### BACKGROUND OF THE INVENTION

1. Field of Invention

The present invention relates to digital video compression, and, more specifically to the efficient video bit stream encoding method and apparatus that results in the saving of computing times.

2. Description of Related Art

Digital video has been adopted in an increasing number of applications, which include video telephony, videoconferencing, surveillance system, VCD (Video CD), DVD, and digital TV. In the past almost two decades, ISO and ITU have separately or jointly developed and defined some digital video compression standards including MPEG-1, MPEG-2, MPEG-4, MPEG-7, H.261, H.263 and H.264. The success of development of the video compression standards fuels the wide applications. The advantage of image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-frame or P-frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In most video compression standards including the MPEG 1, MPEG 2 or MPEG 4, there are six to eight syntactical layers of video streams which includes video sequence, group of pictures (GOP), picture, slice, macroblock and block layers. FIG. 1 gives an overview of the six layers in most of MPEG video compression standards. The system layer packs and packets synchronize and multiplex the audio and video bit streams into an integrated data stream. A video stream 11 always starts with a sequence header 12. The sequence header is followed by at least one or more groups of pictures (GOP) 13 and ends with a “sequence end code” 115. Additional sequence headers may appear between any groups of pictures within the video sequence. A group of pictures, GOP always starts with a GOP header 14 and is followed by at least one picture 15. Each picture in the GOP has a picture header 16 followed by one or more slices 17. In term, each slice is composed of a slice header 18 and one or more groups of so named “macroblocks” 19. The 1^{st} slice starts from the upper left corner of a picture and the last slice ends in the lower right corner. The macroblock 110 is composed of a group of six 8×8 DCT blocks 111—four blocks contain luminance, Y samples and two contain chrominance, Cb, Cr samples. Each macroblock starts with a macroblock header 110 containing information about which DCT blocks are actually coded. All six blocks are shown in FIG. 1 even though in practice, some of the blocks might not be coded. DCT blocks are coded as intra or non-intra, referring to whether the block is coded with respect to a block from another picture or not. If an intra block is coded, the difference 112 between the DC coefficient and the prediction is coded first. The AC coefficients are then coded by using the variable-length codes (VLC) 113 for the packed “Run-Level” pairs until an “end-of-block” 114 terminates the block encoding.

In the non-intra picture encoding, the first step is to identify the best match block followed by encoding the block pixel differences between a target block and the best match block. For some considerations including accuracy, performance and encoding efficiency, a frame is partitioned into macro-blocks of 16×16 pixels for estimating the block pixel differences and the block movement, called “motion vector”, the MV. Each macro-block within a frame has to find the “best match” macro-block in the previous frame or the next frame. The procedure of searching for the best match macro-block is called “Motion Estimation”. A searching range is commonly defined to limit the computing times in the “best match” block searching. The computing power hunger motion estimation is adopted to search for the “Best Match” candidates within a searching range for each macro block as described in FIG. 3. According to the MPEG standard, a macro block is composed of four 8×8 “blocks” of “Luma (Y)” and one, two or four ““Chroma (Cb and Cr)”. Since Luma and Chroma are closely associated, in the motion estimation, there is need of the estimation only for Luma, the Chroma, Cb and Cr in the corresponding position copy the same MV of Luma. The Motion Vector, MV, represents the direction and displacement of the movement of block of pixels. For example, an MV=(5,−3) stands for the block movement of 5 pixels right in X-axis and 3 pixel down in the Y-axis. For minimizing the time of searching, the motion estimator searches for the best match macro-block only within a predetermined searching range 33, 36. By comparing the mean absolute differences, MAD or sum of absolute differences, SAD, the macro-block with the least MAD or SAD is identified as the “best match” macro-block. Once the best match blocks are identified, an MV between a target block 35 and the best match blocks 34, 37 can be calculated and the difference between each block within a macro block can be coded accordingly, this kind of block pixel differences encoding technique is called “Motion Compensation”. In the procedure of the motion estimation and motion compensation, the higher accuracy of the best match block, the less bit number will it be needed in the encoding since the block pixel differences can be smaller if the accuracy is higher.

FIG. 2 shows a prior art block diagram of the MPEG video compression, which is most commonly adopted by video compression IC and system suppliers. In the case of I-frame or I-type macro block encoding, the MUX 220 selects the coming pixels 21 to directly go to the DCT, the Discrete Cosine Transform block 23, before the Quantization step 25. The quantized DCT coefficients are zig-zag scanned and packed as pairs of “Run-level” code, which patterns depending on the occurrence will later be counted and be assigned code with variable length 27 to represent it. The compressed I-frame or P-frame bit stream will then be reconstructed by the reverse route of compression procedure 29 and be stored in a reference frame buffer 26 as a reference for future frames. In the case of a P-type or B-type frame or macro block encoding, the macro block pixels are sent to the motion estimator 24 to compare with pixels within macro-block of previous frame for the searching of the best match macro-block The Predictor 22 calculates the pixel difference between a target 8×8 block and the best match block of previous frame (and next frame if B-type frame). The block pixel differences then feed into the DCT 23, quantization 25 and VLC 27 encoding, a similar procedure like the I-frame or I-type macro-block encoding.

Bad or inaccurate measurement of the motion vector, the MV, results in larger difference between a target macro-block and the so called “best match” macro-block which causes higher bit rate of compressed stream data. A higher bit rate causes longer time in transmitting the data and requires more storage device to save the data. Therefore, the compression performance, image quality and bit rate are hence mostly likely conflicting requirements in video compression and become tradeoffs in the video compression system design. Motion compensation, DCT and VCL encoding together consume the second highest amount of computing times next to the motion estimation. Many efforts in the past decades have been put to improve the speed of motion estimation and also in improving the image quality. But the rest of compression procedure as mentioned still dominate high amount of computing in the video compression. This invention provides an efficient bit stream encoding method specifically for the reduction of computing power in the motion compensation, DCT, and other procedure of video compression.

### SUMMARY OF THE INVENTION

The present invention is related to a method and apparatus of the video data encoding, which plays an important role in digital video compression, specifically in encoding the MPEG video stream. The present invention significantly reduces the computing times compared to its counterparts in the field of video compression.
The present invention of the efficient video bit stream encoding includes procedures and steps of quickly screening the pixel data within a frame, a GOB (group of blocks), and an macro-block to determine whether or not the plurality of a frame, a GOB or a macro-block need to go through the steps of the video compression.
The present invention of the efficient video bit stream encoding saves the previously compressed blocks bit stream and determines which bit stream of the previously compressed blocks can be used as a bit stream of a target block to avoid the video compression steps.
The present invention of the efficient video bit stream encoding compares the block pixel differences starting from the neighboring blocks and more quickly determines which bit stream of the previously compressed blocks can be used as the bit stream of the present.
The present invention of the efficient video bit stream encoding includes the comparison of differences of the selected pixels of the multiple regions within a frame and that of the neighboring frames. If high similarity occurs, the frame encoding is skipped and the previously saved bit stream of the neighboring frame is used to represent a target frame.
A block within the region of background or an “Object” with little block pixel differences can copy the bit stream of the corresponding block in previous frame, then, the video compression procedure can hence be skipped.
The present invention calculates the block pixel differences between a target block and the best match block and then determines whether a target block can be skipped to avoid the compression steps.
The present invention determines that “skip block” code can be applied to blocks having no movement with very little or no change of pixel values or blocks having the same motion vector as the frame motion vector with no or very little change.
The present invention of the efficient video bit stream encoding quickly calculates the MAD, the mean absolute difference or SAD, sum of absolute difference of a target block and the best match block and determines whether the neighboring blocks can share the same bit stream and avoid the video compression procedures.
The present invention of the efficient video bit stream encoding efficiently calculates the MAD and the average or sum of the block pixel differences between a target block and the best match block, and determines whether the block pixel differences can be represented by only the DC of the DCT coefficients.
The present invention determines that if the DC coefficient can efficiently represent the block difference, then the rest of AC coefficient are rounded to be all “0s” and an “EOB code, end of block” is followed to represent the completion of a block encoding.
The present invention of the efficient video bit stream encoding efficiently calculates the MAD and the average of the block pixel differences between a target block and the best match block, and determines whether the neighboring blocks can skip the video compression procedures.
After identifying that the DC coefficient can efficiently represent the block pixel differences, the present invention use a look-up table to determine the DC value of the DCT coefficients for representing the block difference.
The present invention compares the block pixel differences between a target block and its surrounding blocks to determine whether the block pixel differences are small enough to avoid the compression steps by copying the bit stream of one of the neighboring blocks to represent the target block.
The present invention of the efficient video bit stream encoding also encompasses a method for determining whether a target block needs to go through the compression procedure or not by comparing the “Threshold Values” to the block pixel differences.
The present invention of the efficient video bit stream encoding also encompasses a method of a modified sub-sampling means with the adaptive sub-sampling ratio in the calculation of MAD and block pixel differences as well as the block pixel variance which results in significant reduction of calculation times without sacrificing much of the accuracy.
The present invention of the motion estimation uses higher sub-sampling ratio for macro-blocks within the region of less movement and uses lower sub-sampling ratio in the region of more movement.
The method is implemented in a device such as a bit stream encoding and a module of a digital video encoder that concurrently implements any of the above methods of the present invention in any combination thereof.

It is to be understood that both the foregoing general description and the following detailed description are by examples, and are intended to provide further explanation of the invention as claimed.

### BRIEF DESCRIPTION OF THE DRAWINGS

FIG. 1 shows the layers of the MPEG bit stream which includes from top to down: the sequence layer, group of picture (GOP) layer, picture layer, slice layer, macroblock layer and block layer.

FIG. 2 is a simplified block diagram of the prior art video compression encoder, which is commonly used in most MPEG encoder system.

FIG. 3 is an illustration of the best match macroblock searching from a previous frame and a next frame. The concept of the searching range is also depicted in this figure.

FIG. 4A illustrates the efficient P-type and B-type frame video compression procedure and method, which results in fast bit stream encoding according to the present invention.

FIG. 4B summarizes the SAD range vs. the means of the block encoding.

FIG. 5 depicts the block diagram of the implementation of the present invention of the efficient bit stream encoding. In this block diagram, the output of the compressed video block data stream are saved into a storage device to determine whether the future blocks can re-use it.

FIG. 6A depicts the block pixel differences encoding mechanism, the block pixel differences comparing is used to determine whether or not the bit stream of a previously encoded block can be shared by the target block.

FIG. 6B depicts an example of the block pixel differences comparison mechanism of the neighboring blocks which more quickly determines which previously compressed block bit stream can be shared by the target block.

FIG. 7 depicts the block pixel differences comparison mechanism for the I-type frame or I-type block encoding, which is used to determine whether or not the bit stream of a neighboring block can be shared by the target block.

FIG. 8 depicts the block pixel differences comparison mechanism for the non-intra block encoding and the DC coefficient mapping.

FIG. 9 depicts the concept of pixel selection of the sub-sampling means in the MAD/SAD calculation as well as in calculating the block pixel differences. The periodical interleaving means of the pixel selection is also demonstrated in this figure by 2:1 and 4:1 sub-sampling ratios.

FIG. 10 is the flow chart of the I-frame or the l-type block encoding.

FIG. 11 shows a sample of the 8×8 pixel block, the corresponding DCT and the quantized DCT coefficients.

FIG. 12 is an example of the block pixel differences of two blocks and the corresponding DCT Coefficients. It is obvious that after quantization, the AC coefficients are filtered out and only the DC coefficient left.

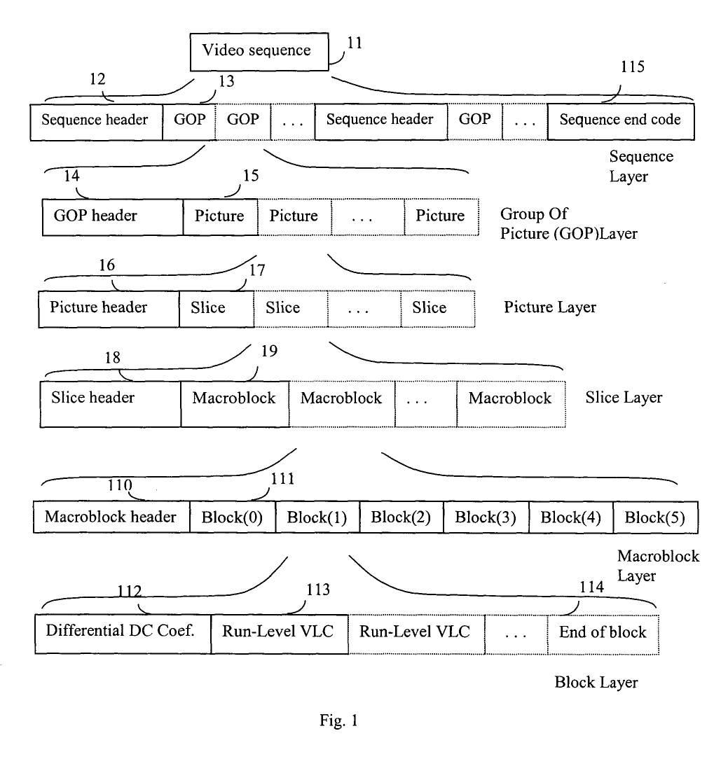

### DESCRIPTION OF THE PREFERRED EMBODIMENTS

The present invention relates specifically to the video bit stream encoding. The method and apparatus quickly encodes the block bit stream data, which results in a significant saving of the computing times.

There are in principle three types of picture encoding in the MPEG video compression standard including I-frame, the “Intra-coded” picture, P-frame, the “Predictive” picture and B-frame, the “Bi-directional” interpolated picture. I-frame encoding uses the 8×8 block of pixels within a frame to code information of itself. The P-frame or P-type macro-block encoding uses previous I-frame or P-frame as a reference to code the difference. The B-frame or B-type macro-block encoding uses previous I- or P-frame as well as the next I- or P-frame as references to code the pixel information. In most applications, since the I-frame does not use any other frame as reference and hence no need of the motion estimation, the image quality is the best of the three types of pictures, and requires least computing power in encoding. Because of the motion estimation needs to be done in both previous and next frames, bi-directional encoding, encoding the B-frame has lowest bit rate, but consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. Therefore, the encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

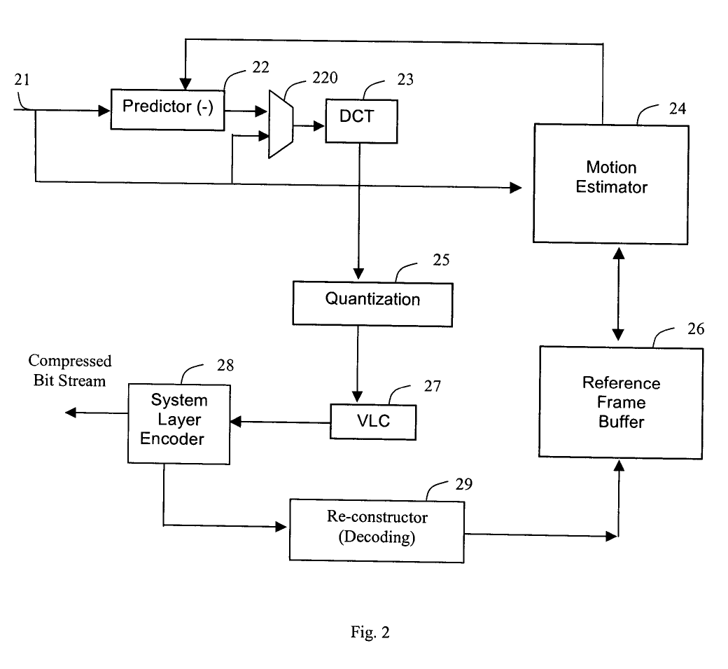

FIG. 2 illustrates the block diagram and data flow of the digital video compression procedure, which is commonly adopted by compression standards and system vendors. This video encoding module includes several key functional blocks: The predictor 22, DCT 23, the Discrete Cosine Transform, quantizer 25, VLC encoder 27, Variable Length encoding, motion estimator 24, reference frame buffer 26 and the re-constructor (decoding) 29. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX 220 selects the coming pixels 21 to go to the DCT 23 block, the Discrete Cosine Transform, the module converts the time domain data into frequency domain coefficient. A quantization step 25 filters out some AC coefficients farer from the DC corner which do not dominate much of the information. The quantized DCT coefficients are packed as pairs of “Run-Level” code, which patterns will be counted and be assigned code with variable length by the VLC Encoder 27. The assignment of the variable length encoding depends on the probability of pattern occurrence. The compressed I-type or P-type bit stream will then be reconstructed by the re-constructor 29, the reverse route of compression, and will be temporarily stored in a reference frame buffer 26 for future frames' reference in the procedure of motion estimation and motion compensation. In the case of a P-frame, B-frame or a P-type, B-type macro block encoding, the coming pixels 21 of a macroblock are sent to the motion estimator 24 to compare with pixels of previous frames (and the next-frame in B-type frame encoding) to search for the best match macro-block. Once the best match macro-block is identified, the Predictor 22 calculates the block pixel differences between the target 8×8 block and the block within the best match macro-block of previous frame (or next frame in B-type encoding). The block pixel differences then feed into the DCT 23, quantizer and VLC encoder, the same procedure like the I-frame or l-type block encoding.

The Best Match Algorithm, BMA, is most commonly used motion estimation algorithm in the popular video compression standards like MPEG and H.26×. In most video compression systems, motion estimation consumes high computing power ranging from ˜50% of the total computing power of the video compression. In the search for the best match macro-block, a searching range, for example +/−16 pixels in both X- and Y-axis, is most commonly defined. The mean absolute difference, MAD or sum of absolute difference, SAD as shown below, is calculated for each position of a macro-block within the predetermined searching range, for example, a +/−16

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

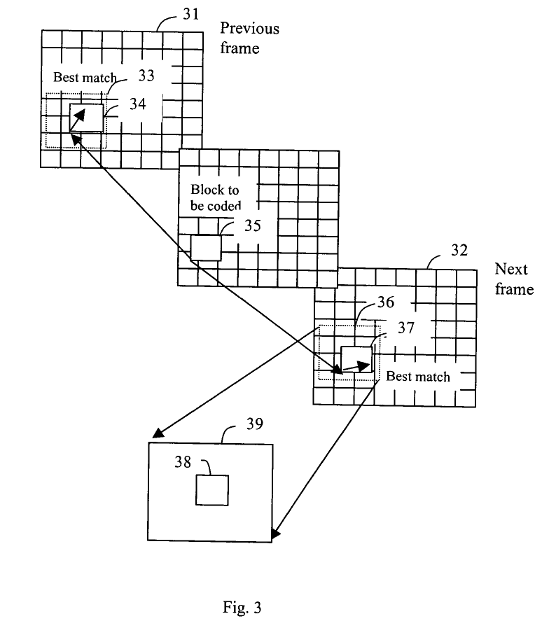

pixels of the X-axis and Y-axis. In above MAD and SAD equations, the Vn and Vm stand for the 16×16 pixel array, i and j stand for the 16 pixels of the X-axis and Y-axis separately, while the dx and dy are the change of position of the macro-block. The macro-block with the least MAD (or SAD) is from the BMA definition named the “best match” macro-block. FIG. 3 depicts the best match macro-block searching and the depiction of the searching range. A motion estimator searches for the best match macro-block within a predetermined searching range 33, 36, 39 by comparing the mean absolute difference, MAD or sum of absolute differences, SAD. The macro-block of a certain of position having the least MAD or SAD is identified as the “best match” macro-block. Once the best match blocks are identified, the MV between the target block 35 and the best match blocks 34, 37 can be calculated and the differences between each block within a macro-block can be coded accordingly, this kind of block pixel differences encoding technique is called “Motion Compensation”.

The block pixel differences between a target block and the best match block are coded by going through the DCT, quantization and VCL encoding. The procedure of calculating the block MV and encoding the block pixel differences is called “Motion Compensation”. The DCT and quantization together consumes about 20% computing power. The VLC encoding consumes around 5-10%, while the motion compensation dominates about another 5%-10% of the total computing power.

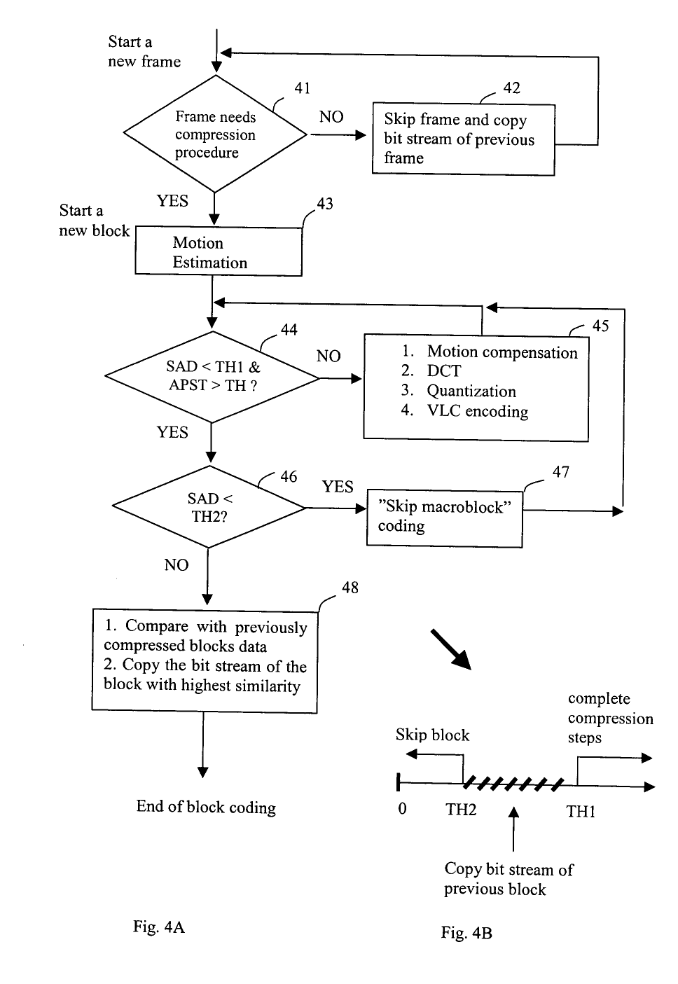

As previously mentioned, the video compression procedure takes “block” as the compression unit, the present invention minimizes the number of blocks that need to go through the complete video compression procedure, thereof significantly reduces the times of computing in video compression. In the present invention, the frame pixels are examined from time to time and partitioned to be “background-like”, “object-like” and others regions for the reference in future frames. FIG. 4A briefly illustrates the video compression procedure and method of the present invention. A coming frame 41 is compared with previous frame by a course sub-sampling means with a predetermined threshold value to decide whether this frame need to go through the video compression procedure or not. If the coming frame has high similarity with the previous frame, then it does not need the video compression, for compliant to MPEG standards, in the present invention, a “skip frame” 42 operation will be applied by copying the previously saved compressed bit stream of the previous frame to represent the present frame. For more efficiently detecting the similarity of a frame to other frames, the sub-sampling mechanism is applied to calculate the frame pixel differences. If the sum or the average of differences of the selected pixels between a frame and the neighboring frame is less than a predetermined value, the frame is identified to be having high similarity and the bit stream of the previously saved neighboring frame is copied to represent the target frame to avoid the procedure of compression. According to present invention, the “skip frame” operation frequently happens in a still image when very little or no change of scene or before the “object” starts moving in the beginning of the video sequence, specifically capturing device is turned on or happens in the very little or no change of background in a monitoring system. For the “skip frame” function to become practical, the compressed bit stream of a previous or next frame is temporarily saved in a storage device, which can be copied to represent the current frame.

If the coming frame needs the normal video compression procedure, then the first step of the block-by-block motion estimation 43 identifies the “best match block” by calculating the MAD, mean absolute difference with a sub-sampling means in present invention.

After identifying the best match block, a target block is examined to determine whether or not it needs the complete video compression steps by checking the position of the block within a picture. If the block is within a background region or within the inner region of an object, said 2-3 blocks away from the edge of an object this block very likely needs no video compression procedure. Otherwise, a complete video compression procedure 45 is needed. For this function to be practically feasible, there are two factors used in the present invention to identify the concept of said “Similarity”. One is the SAD of a block pixels, the other is APST 44, the Amount of Pixel having Smaller than a Threshold value of the pixel difference range (for example, TH is set to +/−3). Which means that the smaller the SAD of a macroblock, the higher similarity. And, the higher the APST, the higher block pixel similarity. When both SAD <TH1 and APST>TH conditions 44 meet, the block does no go through the complete compression procedure 45. The video compression procedure 45, beyond the motion estimation including steps of motion compensation encoding, DCT, Quantization and VLC encoding consumes the second most computing power next to the motion estimation.

The macroblock with no MV or same MV as FMV, the frame motion vector and the MAD value smaller than a predetermined threshold can be assigned “skip macroblock” 47 code to represent it. For this function to be feasible, a predetermined threshold, TH2 is set to compare to the block pixel differences 46. If the SAD is smaller than the TH2, then the “Skip Macroblock” code is enforced. In decoding and display, the blocks within a macroblock having “Skip Macroblock” code just copy the contents of the corresponding blocks in the referencing frame to represent them.

When the SAD falls within TH1 and TH2, said TH2<SAD<TH1, the block does not need the complete compression procedure and can not be coded as “Skip Macroblock”, then the SAD and the APST are used to be compared 48 to those of the previously compressed block and their corresponding best match block to identify which previously compressed block has the highest similarity to present block. When the block with highest similarity is identified, the compressed block bit stream is copied to represent the present block, hence saves the computing power.

FIG. 4B summarizes the procedure of the block compression. When block with the SAD larger than TH1, this block goes throught the complete compression steps, when smaller than TH2, a “skip block” code is assigned to avoid compression steps. If SAD is between TH1 and TH2, the block pixel differences comparison mechanism is applied to identify which bit stream of previously compressed block can be used to represent the target block.

In the case of a block pixel differences is not that close to avoid the complete compression procedure 45, then the block pixel differences are compared to another adaptively predetermined threshold value which is determined by the quantization steps to determine whether the range of the block pixel differences is small enough to ignore the potential AC coefficients if a conventional DCT is executed. The DCT, Discrete Cosine Transform consumes the 2^{nd} highest times of computing in most video compression standard. DCT equation:

$$F ( i , j ) = \frac{1}{\sqrt{2 N}} C ( i ) C ( j ) {\sum }_{x = 0}^{N - 1} {\sum }_{y = 0}^{N - 1} f ( x , y ) cos \frac{( 2 x + 1 ) i π}{2 N} cos \frac{( 2 y + 1 ) j π}{2 N}$$

After the DCT transform, the more close to the left top corner AC coefficients, dominates more information. From the other hand, the closer to the right bottom, the less information the AC coefficient dominates. Therefore, the AC farer away from the DC and left top corner can be filtered out to be “0s” by quantization step without sacrificing much image quality.

If the block pixel difference range is smaller than an adaptively predetermined threshold, after the quantization with a predetermined quantization scale which is decided by the image quality and buffer, bit rate controller, then all AC coefficients are filtered out to be 0s and only the DC coefficient is left. If there is only DC left, then a very short “End of Block”, EOB, said “10”” code is assigned to represent the completeness of the block encoding. A table 85 listing the potential DC values of block different mean value is implemented to map the DC instead of computing power hunger calculation of the DCT equation. If the block pixel differences is beyond the predetermined threshold value compared to the neighboring block, then, a DC coefficient mapping plus only some limited amount of AC instead of all coefficients calculation should be applied.

The sub-sampling means is applied to quickly partition a frame into “background-like”, “object-like” and “others” regions for reference in video compression. Blocks of previous frame having the same MV with the FMV are identified as the “background-like” blocks and need no video compression procedure if the block pixel differences is small, then the bit stream of the respective block in previous frame can be copied to be its bit stream. Similar to the background like block checking, the sub-sampling means can identify a block within an object with small block difference, then the bit stream of the respective block of previous frame can be copied to represent the present block. Blocks having complex patterns or out of the background or object are subject to going through other compression procedure.

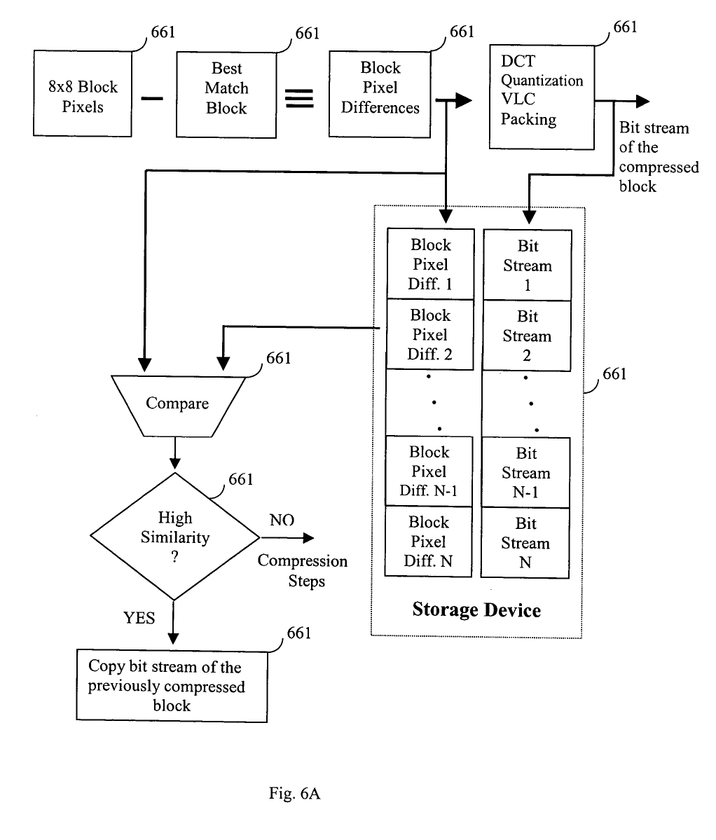

FIG. 6A illustrates the method and mechanism of the block pixel differences comparison which results in the significant saving of computing times in the P-type and B-type frame or macroblock compression. After identifying the best match block through the procedure of the motion estimation, the block pixel differences 663 between the target block 661 and the corresponding best match block 662 is calculated and compared 666 to those of the previously saved block differences. Through the block by block comparing, if the similarity of any of the block pixel difference is high 667, the bit stream of the previously compressed block difference is copied to represent the target block's block pixel difference. If the degree of similarity is not high, then, the block needs to go through the complete compression procedure, the DCT, quantization, VLC and data packing and being saved into the storage device 665 for future block difference comparison. In our simulation of video sequences, depending on the quantization step and the precision in defining the “similarity”, the 1584 CIF (each block consists of 352×288 pixels) blocks of pixels have been reduced to be about 100 to 600 patterns of blocks which are saved in the storage device 665. This represents a 2.67× to 16.0× saving of computing times.

FIG. 6B showing only some blocks, is an example illustrating the concept of block correlation and a procedure of identifying the block similarity. Due to the factor that the block correlation will be higher in neighboring blocks, the block differences comparison starting from neighboring blocks can much quickly find the block having high similarity. A target block 644 within the present frame 62 is surrounded by an upper row of blocks 64, 641, 642 and the left block 643. Blocks 63, 631, 632, 633, 634 within the previous frame 61 are the corresponding best match blocks. The block pixel differences 681, 682, 683, and 684 are the differences between the blocks 64, 641, 642, 643 of the present frame 62 and their corresponding best match blocks 63, 631, 632, 633, 634 in the previous frame 61. Block pixel differences and the corresponding compressed bit stream are saved temporarily in a storage device. The block pixel differences 613 between the target block 644 and the best match block 634 is compared to the block pixel differences of its surrounding blocks, 681, 682, 683 684 to decide which block pixel differences is the nearest one. If the nearest one is smaller than a predetermined threshold value, then its compressed bit stream is copied to represent the target block. The block compression procedure by the means of comparing the block correlation among blocks as illustrated in the FIG. 6B can be expanded to compare all blocks within a frame which significantly reduces the computing times by avoiding the complete compression operations, the DCT, quantization and VLC encoding. Conclusively. The compressed block bit stream of all blocks within a frame are saved into a storage device and their uncompressed block pixels are compared to the target block to determine which of the previously compressed blocks is the nearest one which bit stream can be used to represent the target block.

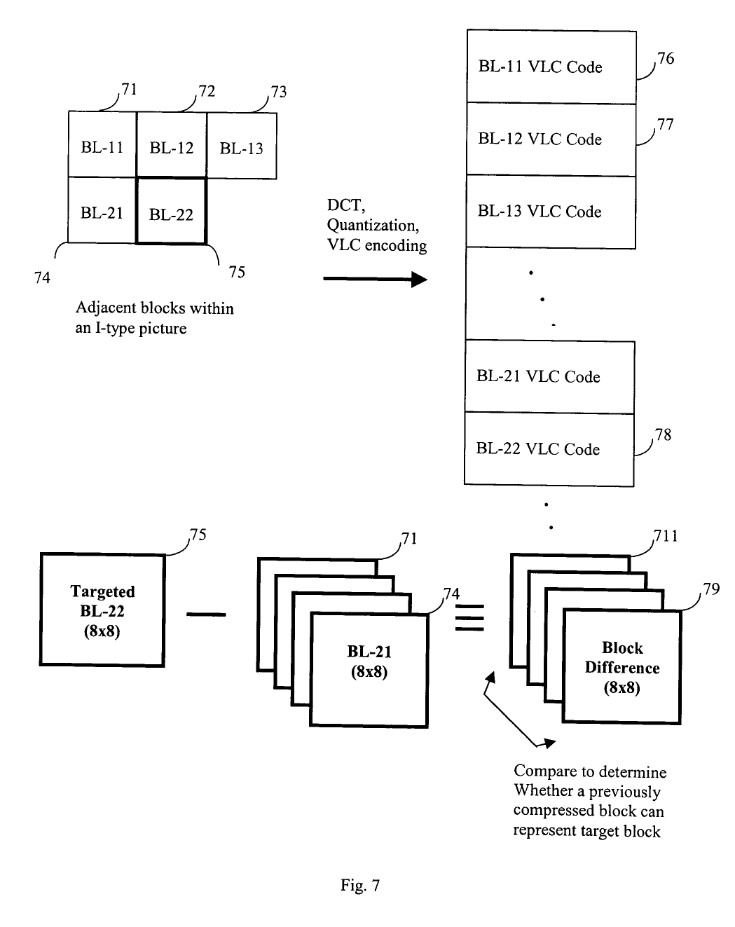

If the block pixel differences is beyond the predetermined threshold value and no equal block is identified, then the block pixel differences is compared to another predetermined threshold value which is decided by the quantization to check whether the variance range of the block pixel differences is small enough to ignore all AC coefficient of the DCT. FIG. 8 demonstrates the means of the block pixel differences and the corresponding DC mapping. In principle, the tolerance of variance is acceptable high since the errors can be easily compensated during the re-construction to avoid degrading the image quality since the block pixel differences 83 represents a small degree of difference of pixel within a block. If the variance is within the predetermined threshold, then all AC coefficients are supposed to be rounded to be 0s and only the DC coefficient left. The present invention implements a lookup table mapping means 85 to identify the corresponding DC coefficient by checking the average or sum of the block pixel differences 84. In many applications, an MPEG video having an MAD of 5-8 is very commonly accepted in image quality which corresponds to, in principle, the average of the block pixel differences is within a small range of +/−1 to +/−5 and its corresponding DC coefficient after DCT is shown in table 1 which lists only a range of (+1, −1). An increase or decrease of ⅛ of the average of block pixel differences or an increase or decrease of 8 of the sum of block pixel difference, represents a change of +1 or −1 in the DC coefficient. Procedures of the present invention illustrated above have proven that a significant saving of computing times is achieved by copying bit stream of the previously compressed block starting from the nearby block when the block similarity is high and by applying the DC coefficient mapping means if the variance of block pixel differences is small. When the variance of block pixel differences is larger than the smallest threshold, a limited amount of AC instead of all 63 AC coefficients are calculated which still results in a significant saving of the computing times. For instance, if the DCT coefficients of an 8×8 blocks has a DC and 5 AC coefficients left non-zero, in the present invention, only DC and left-top 5 AC coefficients are calculated. The decision of how many AC might be left is determined by the block pixel variance range and the quantization steps, the later determines the image quality and the compression rate.

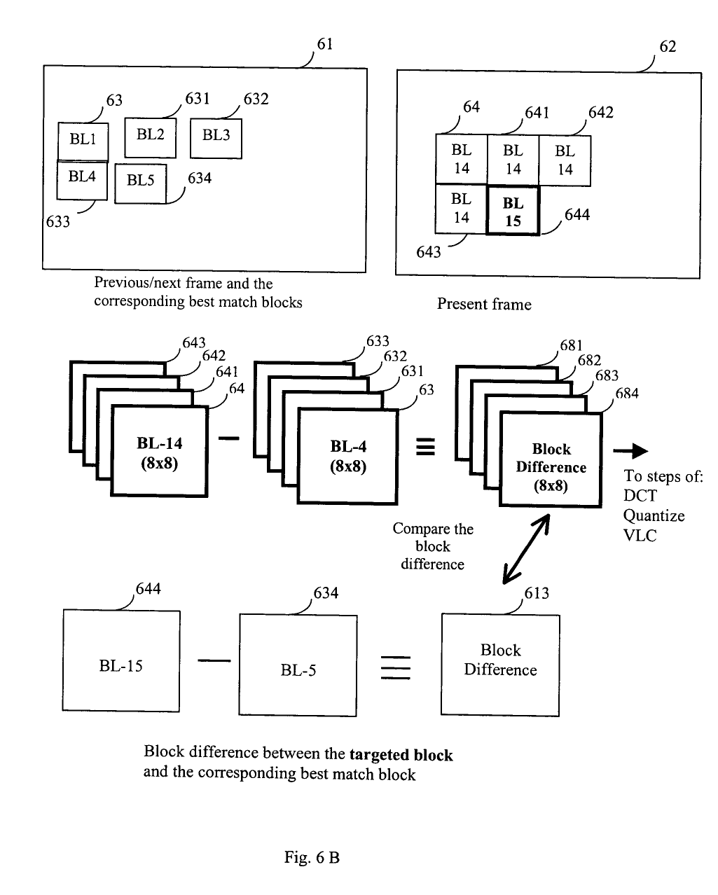

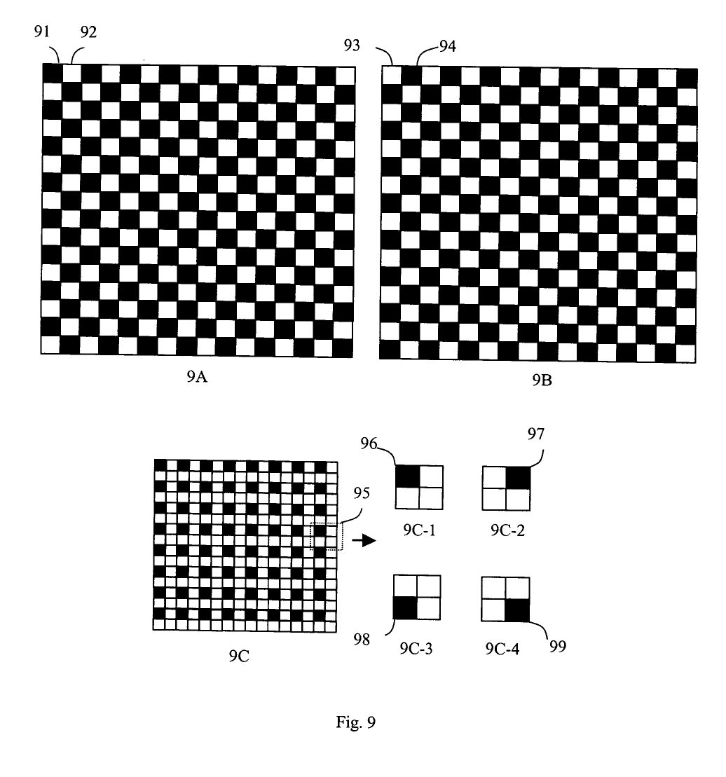

When a frame or a macroblock has higher variance range of pixel values, to ensure the image quality, an I-frame or l-type macroblock encoding are enforced. Under the l-type coding, the present invention applies a means of block comparing to determine whether the block needs to go through the complete compression procedure or need only copying the bit stream of the previously compressed block. FIG. 7 illustrates an example of the block comparing means in the I-frame or I-type macroblock coding. A target block 75 is compared to the surrounding blocks 71, 72, 73, 74. The block pixel differences 79-711 is compared to the predetermined threshold to determine whether the similarity is high enough to copy the bit stream from one of the compressed blocks 76, 77, 78 to represent the target block. FIG. 10 depicts the procedure of the I-type frame or block encoding. If the block pixel value variance is beyond a range 101 set by the threshold TH1, then the block needs to go through the DCT, quantization and VLC encoding steps. When the pixel value variance is between TH 1 and TH 2, then the DC and said some AC coefficients instead of all coefficients are calculated. And if the pixel variance range within a block is less than a predetermine threshold, TH2, then, only the DC coefficient will be mapped to represent the block 104.

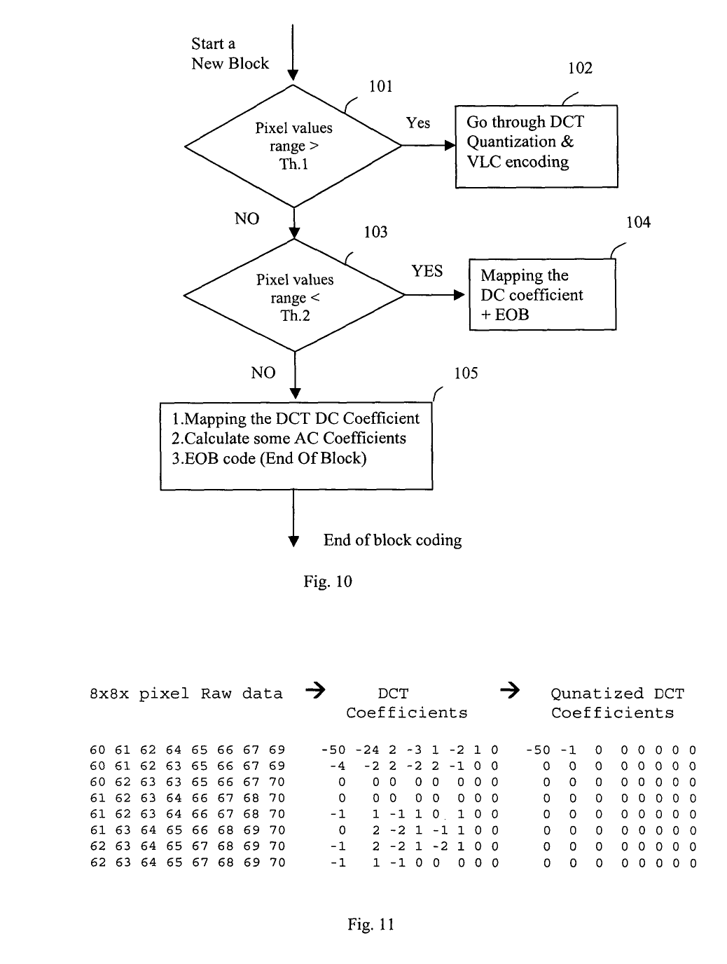

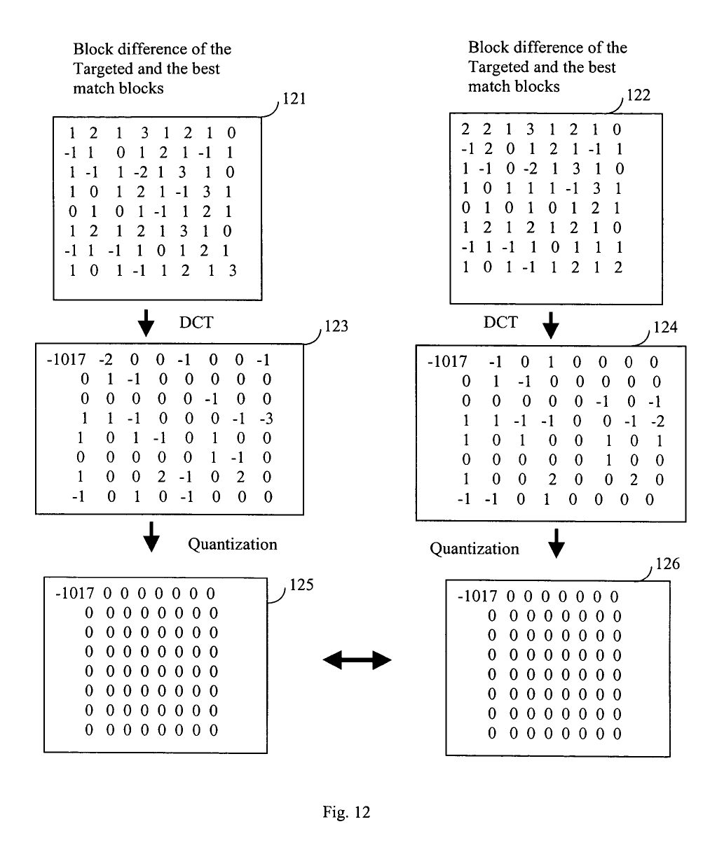

FIG. 11 shows an example of the 8×8 pixel block with variance of 10. After DCT and quantization, for simplicity, the 1^{st} 3-4 AC coefficients of the top-left corner are divided by 16 and larger quantization step beyond. Only one non-zero AC coefficient of “−1” is left. When the pixel value variance narrows down to 5, all AC coefficients are rounded to 0s after quantization by 16.

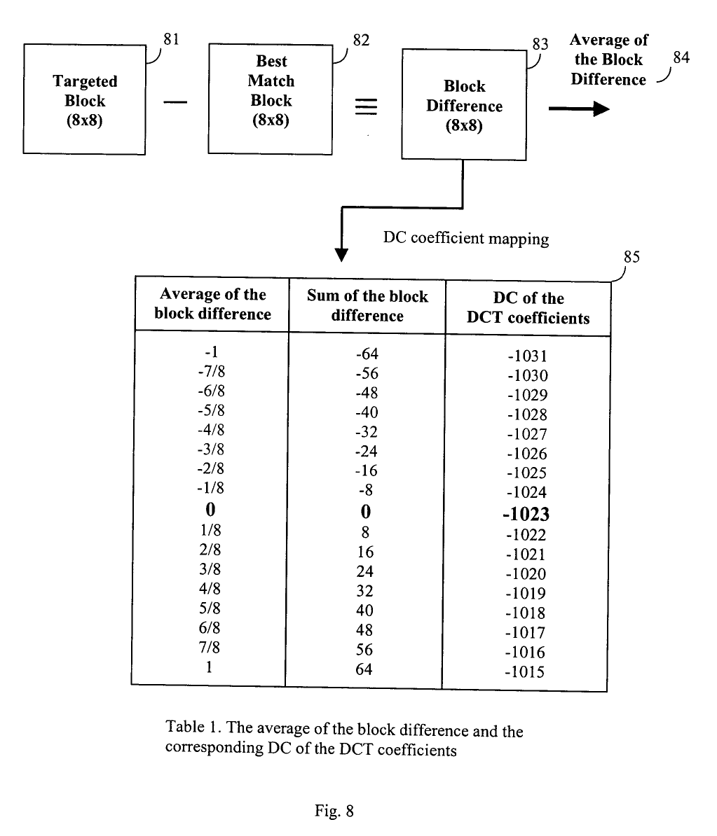

Most of the operations of the present invention as illustrated above, for performance enhancement reason is coupled with the using of the sub-sampling alternative. FIG. 9 illustrates the means of the pixel sub-sampling and examples of 2:1 and 4:1 sub-sampling ratios. Since sub-sampling does not include all pixels in the motion estimation, some degree of potential error is expected. For minimizing the error caused by sub-sampling, the present invention uses an optimized sub-sampling means by periodically rotating the selection pixel of each frame of a video sequence. FIG. 9A shows the 2:1 sampling ratio, in this example, the black position 91 represents the selected pixel, the blank position 92 represents the unselected pixel. In the next frame, as shown in 9B, the selected pixel of previous frame 9A becomes unselected pixel 93, while the unselected pixel in 9A becomes a selected pixel 94. In a video sequence of 30 frame per second which is most commonly supported frame rate, the duration between 2 frames is 30 mili second which is short and the rotation of selecting pixel in a 2:1 sampling ratio means all pixels will be sampled once every 60 mili second. FIG. 9C depicts the 4:1 sampling ratio. Under the 4:1 sampling ratio, the selected pixel of the four pixels is shown in black positions of the 9C1, 9C2, 9C3 and 9C4. Since the sub-sampling ratio is 4:1, the present invention periodically rotates the selecting position 96-97-98-99 from frame to frame in a group of four frames to reduce the error caused by the sub-sampling. The sub-sampling means with optimized selection point is used throughout the complete invention of the bit stream encoding and the calculation of MAD and decision making of skip block and skip frame. Theoretically, the computing speed in the motion estimation and block pixel difference, block variance get doubled by adopting the 2:1 sub-sampling ratio and becomes 4× faster by 4:1 sub-sampling ratio since the number of calculation is proportionally reduced by a factor of 2 in 2:1 sub-sampling ratio and 4 in the 4:1 sub-sampling ratio.

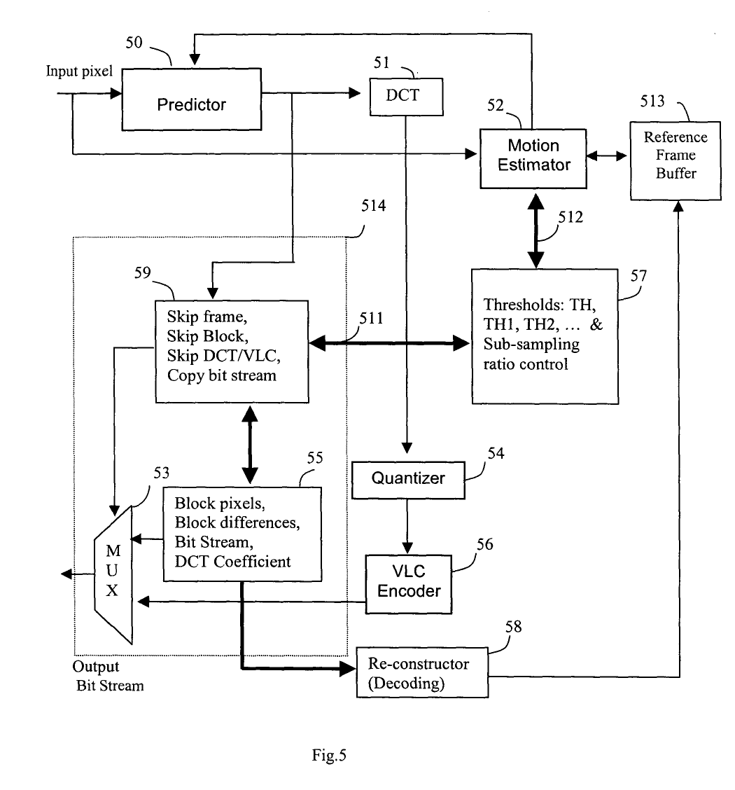

The present invention is implemented in a device a video, an encoding system or a module of a digital video encoder that concurrently implements any of the above methods of the invention in any combination thereof. FIG. 5 depicts the video compression system with the present invention of the efficient bit stream encoding. Since the motion compensation encoding is a macro-block based, in the case of a P-frame, B-frame or a P-type, a B-type macro-block motion compensation encoding, the macro block pixels are sent to the motion estimator 52 to compare with pixels within macro-block of previous frame (and next frame in B-type case) as stored in the reference frame buffer 513 for the searching of the best match macro-block. The Predictor 50 calculates the pixel difference between a target 8×8 block and the corresponding block within the best match macro-block of the previous frame (and next frame in B-type case). The 8×8 block pixel differences from the output of the Predictor 50, compared to some threshold values 57 within the decision making block 59. The decision making block checks the pixel difference conditions and decides whether to “skip frame”, “skip macroblock”, “copy block bit stream”, “DC mapping” and “limited AC coefficients calculation”.

If no similarity, the 8×8 block pixel differences feed into the DCT 51, quantizatizer 54 and VLC encoder 56 for the complete image compression. The later three steps are similar to the I-frame or I-type macro-block encoding. In the present invention, the motion estimator searches for the best match macro-block by calculating the MAD or SAD and compares some adaptively determined threshold values saved in the storage devices. The motion estimator will firstly calculate the frame motion vector, FMV and save it to the FMV storage device. The default or starting of the sub-sampling ratio of applying the sub-sampling means is set to be 2:1, there are three other options of 4:1, 8:1 and 16:1. In the case of higher MV values which very likely has larger movement and potential larger change of pixels content between frames, the sub-sampling ratio is set to lower ratio said 2:1 or no sub-sampling to ensure the accuracy of searching and low bit rate in compressed stream. The motion estimator 52 also checks the adaptively predetermined threshold value 57 of every macro-block to decide whether a refiner resolution said ½ or ¼ pixel is needed. If a refiner resolution is needed, the motion estimation constructs the 16×16 macro-block pixels by interpolation means with adjacent pixels for the use of the best match searching. The sub-sampling ratio control engine adaptively determines the sub-sampling ratio for next of each macro-block of frame motion estimation. When the motion estimator obtains the MAD with no value or with a value lower than an adaptively set threshold values, the “Skip Block” flag will be set for motion compensation encoding, and the block will contain no DCT data. In the video decoder's point, when receiving the “skip block” code, the decoder will copy the same block pixels of the corresponding previous frame or the corresponding next frame depending. During the MAD calculation by sub-sampling or non sub-sampling means, if a value of single pixel difference or sum of the difference higher than an adaptively predetermined threshold value, the motion estimator 52 stops the rest of calculation and gives up the current macro-block and moves to the next candidate. The determination of the adaptive threshold values and sub-sampling ratio setting is based on the movement and the pattern complexity of the target macro-block. In the case of fast movement with higher MV value, the threshold value of higher pixel resolution, the minimum value of MAD of the said “best match” will be set lower to ensure the accuracy of the motion estimation. After identifying the initial point, a full searching of the best match of calculating the MAD is done within the motion estimator 52. The data bus 511 helps in connecting function blocks and transferring data among the MV, FMV and skip frame, skip block, skip DCT and other control status register 59. The compressed bit streams of nearby and previously compressed blocks are temporarily stored in a stream buffer 55. When “skip frame”, “skip block” or “copy block bit stream” is enabled, the corresponding bit stream is copied to represent the current frame or current block. A DCT lookup table is also available for quick mapping of the DC coefficient within a block if other AC coefficients are rounded to 0s. A multiplex, the MUX 53 is implemented to select the output stream from either the previously compressed frame or block bit stream buffer, DC lookup table or from the output of the VLC encoder 56.

The main difference between conventional prior art design and present invention in implementation is the addition 514 of module of the decision making 59, compressed steam buffer 55, DC mapping buffer, MUX 53 and the control register storing some threshold values and the sub-sampling control 57.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

1. A method for encoding a video bit stream, comprising:
storing a compressed bit stream of at least one previous block and corresponding block pixel differences in a storage device, wherein the block pixel differences are compared between a previous block and a corresponding best match block;
calculating block pixel differences between a target block and a corresponding best match block; and
representing bit stream of a target block with the bit stream of a previously compressed block.

2. The method of claim 1, further comprising a step for representing a target frame with a compressed bit stream of a neighboring frame if a sum or an average of differences of selected pixels between the target frame and at least one neighboring frame is within a predetermined threshold value.

3. The method of claim 2, wherein a threshold value is compared to block pixel differences of at least two blocks within the target frame for determining similarity of a target frame to at least one neighboring frame.

4. The method of claim 2, wherein sub-sampled pixels are applied to calculation of pixel differences for a variable region within a frame.

5. The method of claim 1, wherein a “skip block” code is assigned to represent a target block if the block pixel differences between a target block and the corresponding target best match block is less than a predetermined threshold.

6. The method of claim 5, wherein a “skip block” code is assigned to a target block with the same motion vector as the frame motion vector, and block pixel differences between the target block and the best match block is less than a predetermined value.

7. The method of claim 1, wherein in the case that block pixel differences between a target block and the corresponding best match block is similar to block pixel differences of a previously compressed block and the corresponding best match block, then the saved bit stream of a previously compressed block is used to represent a target block.

8. The method of claim 1, wherein a sub-sampling method is applied to decide the DCT coefficients.

9. The method of claim 1, wherein a sub-sampling method is applied to identify the similarity between a target block and at least one previously compressed blocks.

10. A method for encoding a video bit stream, comprising:
comparing the variance range of the block pixel differences to predetermined values; and
using predetermined values to represent DCT coefficients if the variable range of the block pixel difference is within a predetermined value;

11. The method of claim 10, wherein the DC of DCT coefficients of block pixel differences between a target block and the corresponding best match block is represented by a predetermined value by comparing the average or sum of the block pixel differences to predetermined values.

12. The method of claim 10, wherein a certain amount of DCT coefficients of block pixel differences between a target block and the corresponding best match block is calculated.

13. A method for encoding a video bit stream, comprising:
saving a bit stream of at least one previously compressed block into a storage device;
comparing block pixel differences of a target block firstly to neighboring blocks; and
copying the bit stream of a previously compressed block to represent a target block if variance of block pixel differences between a target block and a compressed neighboring block is within a predetermined value.

14. The method of claim 13, wherein DCT coefficients of a block within an intra-coded frame or within a macroblock is represented by predetermined values.

15. The method of claim 13, wherein variance range of block pixels is compared to a predetermined value to decide whether DCT coefficients of a block can be represented by predetermined values.

16. An apparatus for encoding a video stream, comprising:
a storage device for storing block pixels and corresponding compressed bit stream of at least one previous block;
a second storage device for storing predetermined threshold values;
a device for determining the selection of output bit stream; and
an encoding device for utilizing the compressed bit stream of a previous block to represent a compressed bit stream of a target block.

17. The apparatus of claim 16, wherein the block pixel differences between a target block and the corresponding best match block is compared to the block pixel differences of previously compressed blocks and the corresponding best match blocks to determine whether the previously saved bit stream of a previously compressed block can represent a target block.

18. The apparatus of claim 16, wherein the DC of DCT coefficients of block pixel differences between a target block and the corresponding best match block is represented by a predetermined value.

19. The apparatus of claim 16, wherein a bit stream of an intra-coded block is represented by a saved bit stream of a previously compressed block if the block pixel differences between a target block and the previously compressed block is less than a predetermined value.

20. The apparatus of claim 16, wherein a third storage device is used to save predetermined DCT coefficients.

21. The apparatus of claim 16, further comprising a multiplexer, MUX for selecting a source of output bit stream.

22. The apparatus of claim 16, wherein a device of sub-sampling control is applied to calculate block pixel differences between a target block and previously compressed blocks.
